(19) United States
(12) Patent Application Publication
(10) Pub. No.: US 2011/0230176 A1
(43) Pub. Date: Sep. 22, 2011

(54) GUI Based Information Access, Web Search and Browsing over SMS

(76) Inventors: Bipin Pradeep Kumar, Bangalore (IN); Ajay Sethi, Bangalore (IN)

(21) Appl. No.: 13/130,418

(22) PCT Filed: Nov. 20, 2009
(86) PCT No.: PCT/IN2009/000667

§ 371 Date: May 20, 2011

(30) Foreign Application Priority Data
Nov. 20, 2008 (IN) 2870/CHE/2008

(51) Int. Cl. H04W 4/00

(52) U.S. Cl. 455/414.3

(57) ABSTRACT

GUI based information access, web search and browsing over SMS. The embodiments herein generally relate to wireless communication, and, more particularly, to a method and application for creating and presenting information to and from mobile devices using a GUI interface over SMS. At the mobile terminal end it also includes methods for constructing an SMS comprising of information the user seeks and other matter recorded and transferred to the server to create responses and influence subsequent interactions. The method employs SMS transfers for communicating between a device based client application and an Internet based server application to simulate browsing over SMS. The method includes formatting of various textual elements including results, ads, actions, community-answers, and other matter or activities to be sent as SMS from the server and a mobile terminal reconstructing and presenting the received text messages to provide a browsing experience.

### BACKGROUND

1. Technical Field

The embodiments herein generally relate to wireless communication, and, more particularly, to a method and application for interacting, creating and presenting information to and from mobile communication devices using a rich graphical web-like user interface over SMS as a means of data transfer.

2. Description of the Related Art

Presently, several techniques have been developed for connecting to or accessing Internet-based information resources using conventional graphical user interface (GUI) based Internet browser programs. Online search using web-based search engines is evidenced as a significant application of computer networks. Currently, the users of mobile devices, such as wireless phones, pagers, and Personal Digital Assistants (PDAs), can also access Internet search tools to search for content.

SMS search services allow a user to text a message to a central database/repository/index and receive a reply using text. This information access is primarily performed by submission of one or more keyword messages from the wireless device to a predetermined number serviced by a server. Based on the available information, the server prepares a response that includes information related to the input keyword message. The SMS message is then delivered to the wireless device that requested the information.

The users of many wireless devices such as cell phones encounter difficulties using search technologies and information access intended for conventional online use. The current methods of finding and using information from the web or an operator portal or partner sites using a cellular phone over SMS is restrictive and largely requires users to follow specified “syntax”—which includes use a prefix of pre-defined keywords (typically, one each for different categories and sub-categories of information). Currently, SMS based information access generally makes limited amount of data accessible to users of the wireless networks. Further, there is no means to access or retrieve search information over SMS via a simple, user-friendly, graphical interface as provided by the web.

Users rely on the capabilities of mobile phones to stay in touch with their friends and family. In a regular scenario, the users also seek and provide feedback to their friends and family during the decision making process. Currently, no method exists for providing access to a user's social network comprising of contacts from the phone address book to an information retrieval service. Also, currently no method exists for obtaining the location of a user and transmitting the location by SMS to obtain location-aware information.

### SUMMARY

Embodiments herein relate to a method for requesting and obtaining specific information from across the whole web over the cellular short message service using a point and click graphical user interface. Also, provided are systems and an arrangement for encoding and formatting data that includes results, links, ads, actions and other activity to be sent as cellular short messages from the server and at the mobile terminal reassembling, constructing and presenting the received text messages, in accordance, to provide a browsing experience.

In view of the mentioned, an embodiment herein also provides a method for requesting and obtaining specific information from the Internet over a Short Message Service (SMS) using a Graphical User Interface (GUI). The messages can be rendered in a browser based application or be loaded in an application, developed using various mobile application development technologies such as Symbian, Java ME or Binary Runtime Environment for wireless (BREW). The communication between the server and the application resident on the phone—the client occurs over SMS', in a single SMS or multiples of SMS for the same information.

The embodiments disclosed herein further provides systems and arrangement for encoding and formatting data that includes results, links, ads, actions and other elements to be sent as cellular short messages from the server and reassembling, constructing and presenting the received text messages at the mobile terminal to read the search response or continue to browse for desired result. Should there be a need to obtain more info or refine the information from the already obtained information, clicking on the result; similar to on the web would get the linked information. The click is translated into a SMS message and sent to the server. SMS based communication between client and server can be further optimized by using compression. SMSs can also be used to transmit low-resolution graphic elements such as operator logos, image-based ads, icons and the like from the server. The application can be installed on the device.

The embodiments disclosed herein further provide a method for recording usage, consumption patterns and interaction feedback and subsequently transferring the data to the server. These provide vital feedback about the effectiveness of the search results and can also be used to influence subsequent interactions for the user in particular and other users in general. The device's address book can be loaded into the application environment, providing an ability to select one or multiple contacts to send the search results, by sending a message to the server including the text and selected contact details. Further, the location of user device by virtue of geographic location or location derived from cellular connectivity can be obtained and transmitted to the server at the time of initiating a search or browse. Furthermore, the movement, usage and consumption patterns including frequented locations, calls and SMS sent in reaction to a received message, addresses saved to a device after viewing the information etc. provide information to bias subsequent results and important feedback about the effectiveness of the search results. Moreover, this metadata can also be used to ascertain the accuracy and correctness of the results provided to the users. This is especially true for SMS-based information access—because there is no direct way to capture and transmit feedback (as captured by various phone-based activities) back to the service.

These and other aspects of the embodiments herein will be better appreciated and understood when considered in conjunction with the following description and the accompanying drawings. It should be noted, however, that the following descriptions, while indicating preferred embodiments and numerous specific details thereof, are given by way of illustration and, not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram depicting the process elements of a SMS based web search and browse application in accordance with the embodiments herein

FIG. 2 illustrates a schematic diagram depicting the network architecture of a SMS based web search and browse application in accordance with the embodiments herein;

FIG. 3 illustrates a logical diagram depicting the system architecture of a SMS based web search and browse application in accordance with the embodiments herein;

FIG. 4 illustrates a schematic diagram depicting the structure of a SMS used for web search and browse application in accordance with the embodiments herein;

FIG. 5 illustrates a flow diagram depicting a method of requesting and obtaining information using a SMS based web search and browse application in accordance with the embodiments herein; and

FIG. 6 is a schematic diagram depicting the user interface for providing search and browse results over SMS to a wireless device in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

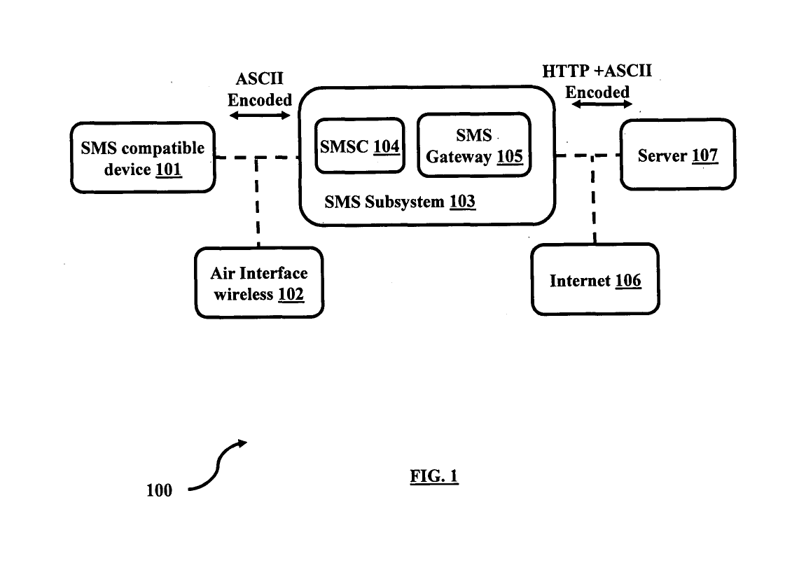

The embodiments herein disclose a method for providing web like browsing and search over SMS to a client device using a point and click Graphical User Interface (GUI). Referring now to the drawings, and more particularly to FIGS. 1 through 6, where similar reference characters denote corresponding features consistently throughout the figures, there are shown preferred embodiments.

Embodiments herein disclose a method and system for requesting and obtaining specific information from the Internet or from specific servers over a Short Message Service (SMS) to the user's cellular device using a point and click Graphical User Interface (GUI). An application, which can be installed on the user device such as a mobile phone, sends the request from the user in the form of a SMS processes the responses received and presents the GUI to the user. The method includes deconstructing and constructing various textual elements that includes results, ads, community-answers, meta-information, and subscription messages in a fashion that provides a web based search and a browsing experience complete with links, graphical elements and interfaces using SMS as a medium of transmission. Subsequent interactions to obtain more information or to refine details are initiated based on a click and sent as a SMS. In the case of an action such as a Call, SMS or save or any other action from the user, these are stored for transfer during subsequent interactions. The app also provides ability for selecting one or multiple contacts from the device's address book to send search results and seek their input. Further, the location of the client device can be obtained and transmitted to the server at the time of initiating a search or browsing session.

FIG. 1 illustrates a block diagram depicting the process elements of a SMS based web search and browsing application in accordance with the embodiments herein. The elements include an SMS compatible device 101, a wireless air interface 102, an SMS subsystem 103, the Internet 106 and a server 107. The SMS subsystem 103 includes a Short Message Service Center (SMSC) 104 and a SMS gateway 105. The user may demand information or initiate an activity from the application by sending a request to the server, the request can be sent as a SMS from an SMS compatible device 101 over a mobile wireless air interface 102. The request sent from the device 101 may comprise of a query which contains the entire string that has been entered. The request from the device 101 may also be an identifier to continue a search, which is already in progress on the device 101. The request from the device 101 may also comprise any one of the following: an indicator for an action event; where the action event may be any event performed by the user like clicking a link in the page presented to the user, a reference to an advertisement, the location of the requesting device 101, mobile numbers from the contact or address book of the device 101 and a message entered for communication to a third party. The requests sent to the server can be generated by the text entered in an area specified for the text entry, a click on a particular part of the result, a click on an action element, selection of contacts from the contact or address book of the device 101, or text composed to send to selected contacts from an area specified for entry. The location of the user using the device 101 may also be a part of the query. The wireless air interface 102 transmits information over the air between base stations and mobile units. The SMS is stored in the Short Message Service Center (SMSC) 104, which is a network element in the mobile telephone network which delivers SMS messages to the destination user when they are available. The SMS Gateway 105 connects to an SMSC 104 on one side and connects to the server 107 on the Internet 106 on the other side. SMS gateway 105 functions as a gateway between the GSM network and the Internet 106, providing Internet 106 information to mobile—subscribers using SMS messaging. The response to the request sent from the device 101 may comprise of a single SMS or multiple SMS. If the response comprises of multiple SMS, then the SMS may come in non-sequential order. If the response is in the form of multiple SMS, then the SMS received at a specific instant has to be analyzed to determine the position of the SMS in the sequence of SMS that is to be received as part of the response to the query. Once the last SMS in the sequence of SMS is received, the device 101 has to stop listening for further SMS. Also, once the final SMS is received, the device 101 has to reconstruct the response from the plurality of received SMS and present the response to the user in accordance with the structure as intended by the server. The response can be rendered in a browser or in an application such as Symbian, Java ME or BREW in multiple formats like regular plain text; formats based on JavaScript Object Notation or XML encoded results. The interpreted and reconstructed message that is presented to the user comprises of fields like information or suggestions, which the user can use to further refine the query, snippets of results which the user can use to obtain further information, result specific actions which the user can use to fulfill related tasks and advertisements or coupons which can be used by the user. The application renders arrangements for encoding and formatting search results, links, ads, actions and other activities as SMS from the server to the mobile. The messages are reassembled, reconstructed and presented at the mobile terminal providing a browsing experience. The data is encapsulated to provide abstraction while sending, as there are various message types. Further, metadata on messages to be sent from client to server are stored till an opportune time for transmitting the metadata. The metadata includes action taken on a call or SMS, invalid phone numbers, codes, URLs, duration of the call, unresponsive SMS codes, action taken on adds and the like. Snippets of personalization information can also be sent as SMS. The personalization information includes commonly used terms from messages, frequently called contacts, or location recurrences to interpret areas more frequently present. Metadata and snippets can be appended to the user initiated requests for transmission to save transmission costs. The metadata can be appended and sent with search queries, subscription requests or messages to contacts. Server to client communication can be in a single SMS or multiple SMS for same information. The SMSs are received, reconstructed and parsed for making the data comprehensible. The application uses the phone book of the device 101 as the primary social network of the user.

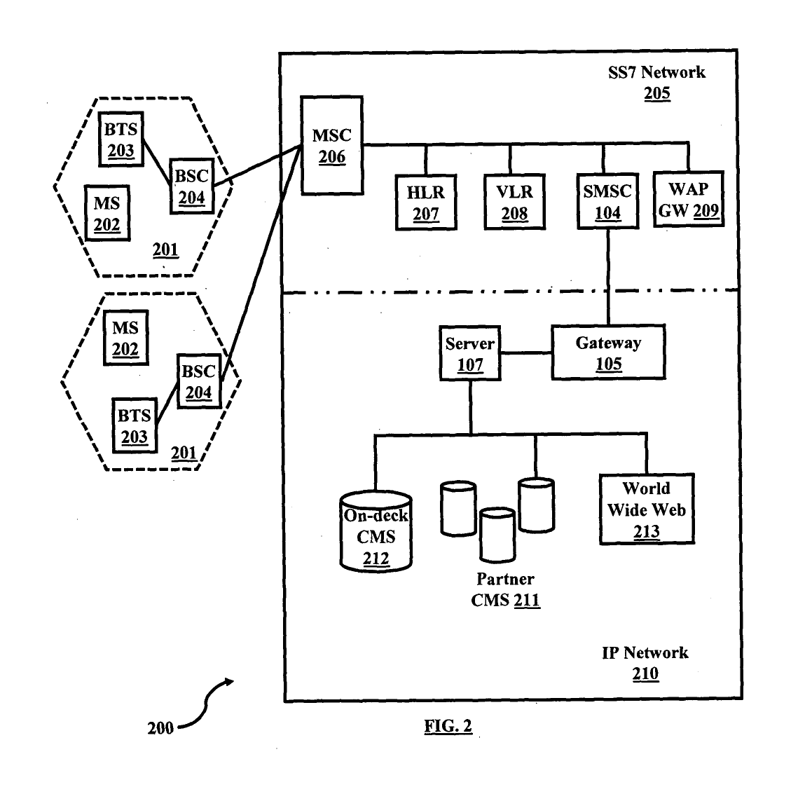

FIG. 2 illustrates a schematic diagram depicting the network architecture of a SMS based web search and browse application in accordance with an embodiment herein. The network architecture includes a mobile network 201, a Signaling System No 7 (SS7) network 204 and an IP network 210. The mobile network 201 includes a mobile station (MS) 202 comprising all user equipment and software needed for communication with a Wireless telephone network. MS 202 refers to a mobile phone or device held by the users in the mobile network. A base transceiver station (BTS) 203 facilitates wireless communication between MS 202 and a network through a base station controller (BSC) 204. BSC 204 is a combination of device 101 and software used by a base station which enables the base station to register mobile phones in the cell (a geographic area) to perform handoff, call setup and call termination. The SS7 network 205 comprises a Mobile switching Center 206, Home Location Register (HLR) 207, Visitor Location Register (VLR) 208, a Short message service center (SMSC) 104, a WAP gateway 209, and the IP network 210 includes a gateway 105, a partner Call Management System (CMS) 211, on-deck CMS 212, Server 107, and internet 106. The base stations route the communications to the MSC 206 via a serving BSC 204. A mobile switching center 206 includes a database for storing location information and the call or SMS details of a mobile terminal. The Home Location Register (HLR) 207 is the main database of permanent subscriber information for a mobile network. The HLR 207 interacts with the MSC 206, which is a switch used for call control and processing. The third integral element is the Visitor Location Register (VLR) 208 associated to MSC 206 contains all subscriber data required for call handling and mobility management for mobile subscribers currently located in the area controlled by the VLR 208. VLR 208 maintains temporary user information (such as current location) to manage requests from subscribers who are out of the area covered by their home system. A WAP Gateway 209 is a server through which all wireless (WAP) data is transferred from the device (using WAP requests) to content sites (in WML format) and back to the device 101. An on-deck and partner call management system (CMS) 211, 212 are information storage means in which customers submit information. (either verbally, by e-mail, as Internet data, or via some other form of communication), the call centre deals with that information, and the response is sent back to the user device 101. The Internet offers a suite of protocols that are beneficial to a call management implementation; this enables coverage of geographically dispersed customers, call agents, or engineers, and provides broad support for multiple data formats. The server 107 is a mobile answer engine which helps to quickly get answers, and acts on them and identifies the really clear answers upfront, or interactively narrows down the search and connects to the SS7 network 205 through a gateway 214. The World Wide Web (WWW) 213 is a system of interlinked hypertext documents accessed via the Internet. A user can view Web pages that may contain text, images, videos, and other multimedia and navigate between them using hyperlinks. The result based actions such as call, SMS, save, action responses as call success and duration, call failure and reason, invalid links, SMS success , SMS failure, actions taken on ads, and the like are stored for appropriate time of transmission. The feature provides ability for selecting one or more contacts to send a result and also sending messages to multiple selected contacts. Further, the location of the device 101 is obtained and transmitted to the server at the time of initiating communication. Location of the client can be obtained by virtue of the cell id and location area code or base ID in GSM and CDMA phones respectively. If the device 101 has GPS, then the location of the device 101 can also be obtained by using the latitude and longitude of the device 101.

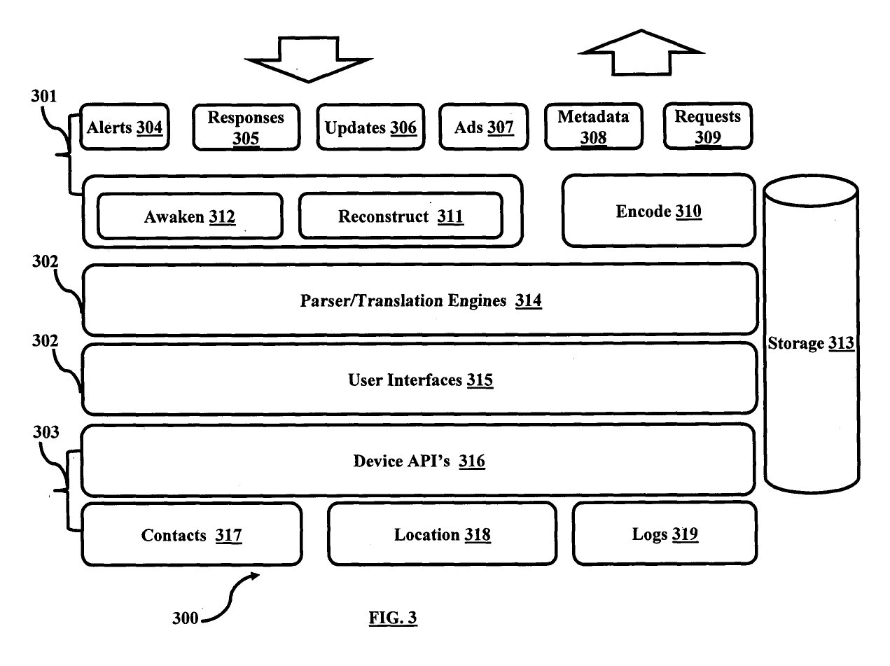

FIG. 3 illustrates a logical diagram depicting the system architecture of a SMS based web search and browse application in accordance with an embodiment herein. The architecture includes an Input/Output (I/O) module 301, a presentation module 302 and a device module 303. The I/O module 301 includes messages involved in client to server communication such as alerts 304, responses 305, updates 306, Ads 307, metadata 308, requests 309, to encode 310, awaken 311 and reconstruct 312 the I/O. The result based actions meant for appropriate time of transmission are stored in storage 313. The presentation module 302 includes a parser/translation engine 314 and user interfaces 315. The device module 303 includes device APIs 316 which interact with contact details 317, subscriber location 318, logs 319 and storage 313. The metadata 305 and requests 309 are send as messages from the client to the server. Server to client communication can be in single SMS or multiples of SMS for the same information. The messages are received, reconstructed and parsed such that the entire data is comprehensible. Alerts 303 and subscription messages automatically wake up the client when server sends updates 306 and the messages are subsequently presented in correct context. Application awakening 311 and message interception can be based on SMS push registry, Binary runtime environment for wireless (BREW) directed SMS, or source dependent awakening. Server can also send additional information that can be cached on the phone for subsequent use including ads 307, updates 306 and the like.

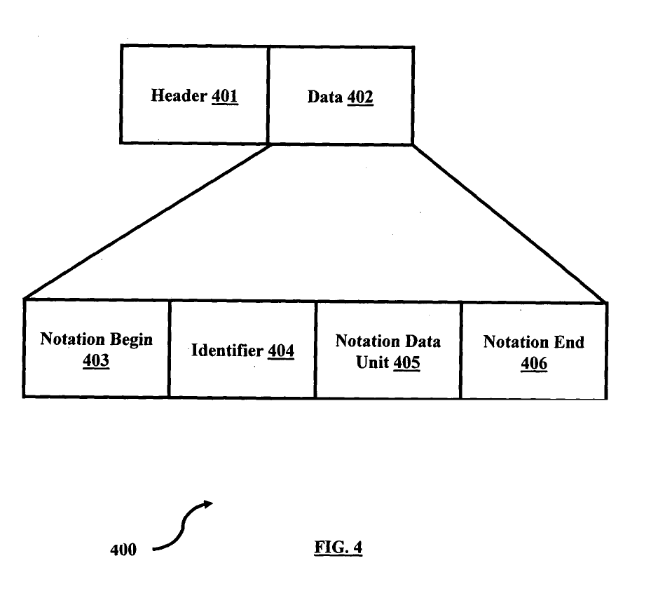

FIG. 4 illustrates a schematic diagram depicting the structure of a SMS used for web search and browse in accordance with the embodiments herein. An SMS comprises of header 401 and data 402. Header 401 is information placed at the beginning of a block of text being transmitted. Data 403 refers to a collection of organized information, usually the search results, ads, meta information such as popular searches or other information within a computer system, or a set of premises. Data 403 can also comprise of extra information that can be cached on the phone for subsequent use. This includes ads, results, updates as well as metadata such as “popular searches” and other trends. Data 403 may consist of numbers, words, special characters or even images encoded in the form of alphabets, numbers or special characters, particularly as observations of a set of variables. The data field 402 further comprises fields of notation begin 403, identifier 404, notation data unit 405 and notation end 406. The notation begin field 403 indicates the start of a particular piece of information along with the representation of the kind of data unit that is being transmitted. Multiple data units can form part of the same SMS. Identifier 404 is a compact string of characters used to identify and relate the set of messages that need to be packaged and interpreted together from the multiples of SMS of a resource being transmitted. The main purpose of the identifier 402 is to enable interaction with representations of the resource over a network, typically the World Wide Web, using specific protocols. SMS based communication between client and server can be optimized by using compression. SMS can also be used to transmit low-resolution graphic elements including operator logos, image-based ads, icons etc from the server.

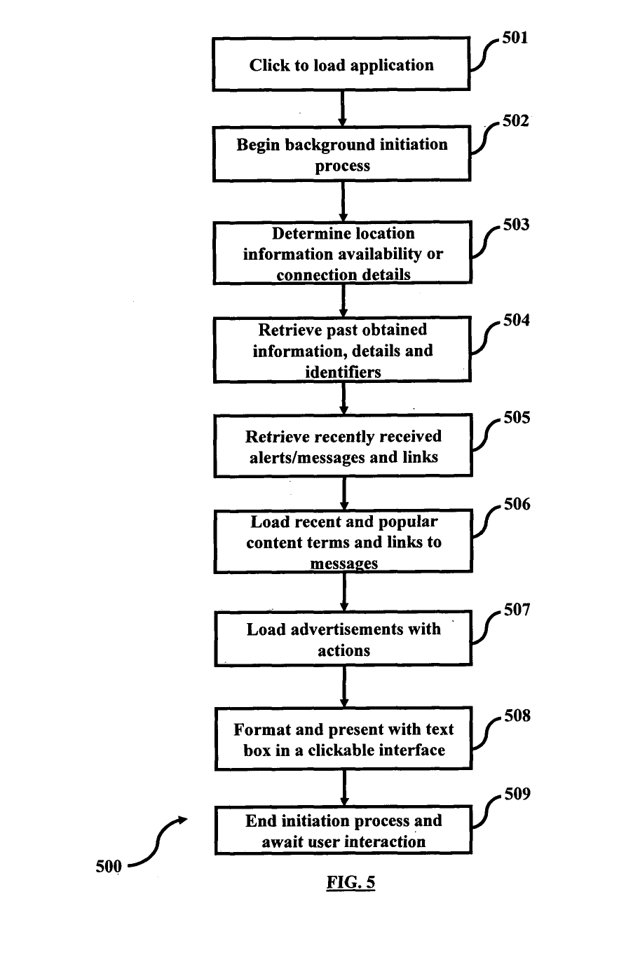

FIG. 5 illustrates a flow diagram depicting a method of requesting and obtaining information using a SMS based web search and browse application in accordance with an embodiment herein. The application is loaded (501) by clicking on the application icon on the device. The application initiation process begins (502) by running a background process that communicates with various processes on the device. The location information availability of the client or the connection details of the client is determined (503) and past obtained information, other details and identifiers to the information are retrieved (504). Further, recent and popular context terms are loaded (505) and the corresponding links if any determined. Then recently received alerts or messages and their links to the messages are retrieved (506) and then advertisements with actions are loaded (507). Further, the user interface with text box and information is formatted with links is presented (508) in a graphical point and click interface. Thereafter, the initiation process is ended (509) and the application waits for user interaction.

Obtaining meta information, updates, ads and other periodic information detailed above occurs by the process of messages being pushed by the server, simulating an always on data connection. As the information gets updated in the background, no user intervention is required for it. The arrangement for all the above further includes methods, handled within the application that comprises the steps of receiving the information in a single or multiples of SMS, processing the SMS and determining the position of the message if multiples of messages received, and in the course of processing the SMS and determining the last message. On receipt of last message, ending listening for the current chain of SMS, reconstruction of the entire information, inferring the type of the message and storing the information on the device 101. The device 101 further stores past searches performed or information retrieved by the user.

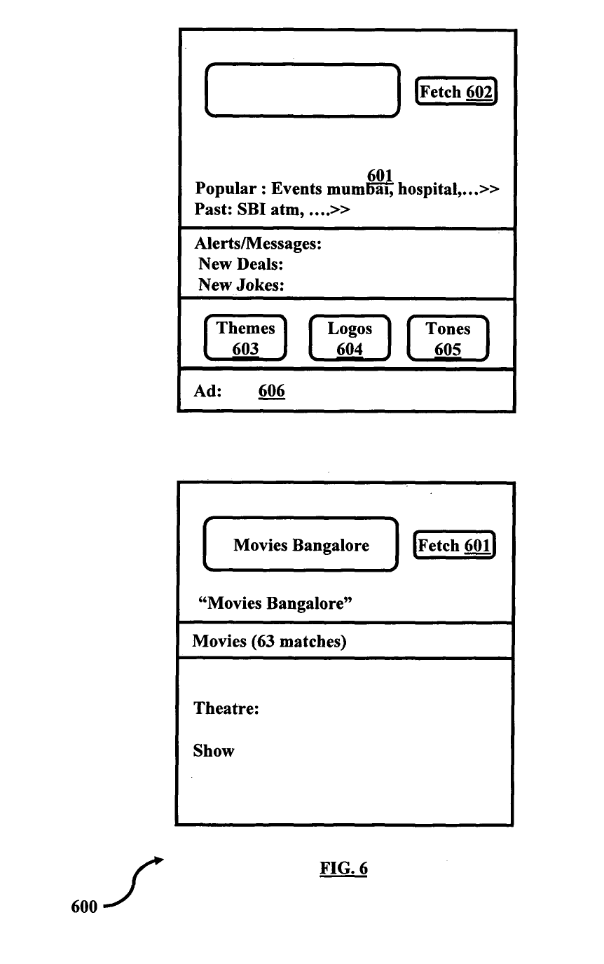

FIG. 6 is a schematic diagram depicting the graphical user interface for providing search and browsing results over SMS to a device 101 in accordance with an embodiment herein. The interface permits SMS-based search and also light-weight browsing and is presented using a user application, existing on the device 101. The user application on invocation performs the composition and rendering of a main interface that comprises of information on popular content or recently added or updated content, with their terms and further links to the content. The content could be available on the internet or in a closed environment on particular mobile operator or content provider server. The application also renders popular content and added or updated content obtained from the internet or within the confines of a mobile operator or content provider systems with the actual text, their respective sources and the links to view detailed information wherever possible. The application also renders advertisement messages with their text the possible associated interaction attributes as activities to exercise action on them. The graphical user interface 600 of the application includes a block 601 where the user can provide the terms to obtain information or keywords to search. The interface generally includes the popular topics searched, past search data, new alerts and messages such as new deals on apparels, foods, and other offers, new jokes, top movies, product reviews and the like. The interface could also provide information of interest to a mobile user such as the latest themes 603, logos 604, top ringtones 605, with the details and the provision for downloading the same. The interface could also provide a space 606 for displaying advertisements. As an example, when a search is required to be done for a particular topic, piece of information or content, the term is typed in the block 601 and sent to the server by clicking the button fetch 602. The information obtained for the term movies for instance, shows all the theatres, movies running in each theatre, show timings, availability of tickets, tickets rate, provision for booking and so on. Further, the interface provides browsing experience by providing options to point and click from among presented information, narrowing down or widening the information retrieval process or search.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the disclosed matter.

What is claimed is:

1. A method for requesting information using a mobile device using Short Messaging Service (SMS), said method further comprising steps of
a user of said mobile device sending a request for information to a server;
said server fetching said information based on said request;
said server constructing a SMS compliant text message with formatting data and said information
said server sending said information to said mobile device using at least one SMS; and
said mobile device presenting said information to said user in a clickable format using a Graphical User Interface (GUI).

2. The method, as claimed in claim 1, wherein said user sends said request to said server using said GUI.

3. The method, as claimed in claim 1, wherein said request is sent to said server in the form of a SMS.

4. The method, as claimed in claim 1, wherein said request further comprises of location information of said mobile device without said user having to type it explicitly

5. The method, as claimed in claim 1, wherein information fetched by said server is based on location of said mobile device.

6. The method, as claimed in claim 1, wherein said server fetches information from at least one of
an information storage means; and
the world wide web.

7. The method, as claimed in claim 1, wherein said SMS sent from said server to said mobile device comprises of advertisements, suggestions for said user and information of interest to said user.

8. The method, as claimed in claim 1, wherein said method further comprises of
said mobile device sending a message to said server, where said message comprises of
action taken by said user on being presented with said information; and
response to said action;
said server updating said information storage means according to said message.

9. A server for providing information to a user though his mobile device, said server comprising at least one means adapted for
fetching information based on a request received from said user;
creating at least one Short Messaging Service (SMS) compliant text message from said information; and
sending said at least one SMS to said user.

10. The server, as claimed in claim 9, wherein said server is configured for receiving said request from said user in the form of a message through the cellular network SMS subsystem.

11. The server, as claimed in claim 9, wherein said server is configured for fetching information from at least one of
an information storage means; and
the world wide web.

12. The server, as claimed in claim 9, wherein said server is configured for fetching information based on location of said user.

13. The server, as claimed in claim 9, wherein said server is configured for creating said at least one SMS, wherein said SMS further comprises of advertisements, suggestions for said user and information of interest to said user.

14. The server, as claimed in claim 9, wherein said server is configured for updating said information storage means on receiving a message from mobile device of said user, wherein said message comprises of actions taken by said user on being presented with said information from said server and response to said action.

15. A mobile device enabling a user to request for information, said mobile device comprising at least one means configured for
enabling a user to send a request for information to a server;
receiving requested information from said server in the form of at least one Short Messaging Service (SMS); and
presenting said requested information to said user in a clickable format in a Graphical User Interface (GUI).

16. The mobile device, as claimed in claim 15, wherein said mobile device is configured for sending said request to said server in the form of a SMS.

17. The mobile device, as claimed in claim 15, wherein said mobile device is configured for sending location information of said mobile device to said server along with said request.

18. The mobile device, as claimed in claim 15, wherein said mobile device is configured for presenting advertisements, suggestions for said user and information of interest to said user along with said requested information.

19. The mobile device, as claimed in claim 15, wherein said mobile device is configured for sending a message to said server, wherein said message comprises of actions taken by said user on being presented with said requested information and response to said action.

20. The mobile device, as claimed in claim 15, wherein said mobile device is also configured for displaying at least one of
popular requests;
most recent requests; and
advertisements.
